(19) United States
(12) Patent Application Publication
(10) Pub. No.: US 2026/0010703 A1
(43) Pub. Date: Jan. 8, 2026

(54) TOOL FOR GENERATING STRUCTURED DATA WITHIN HIERARCHICAL OUTLINES AND AUTOMATIC TRANSFORMATION INTO OTHER FORMATS

(71) Applicant: EXPERCEPTION LLC, EVANSTON, IL (US)

(72) Inventors: Steven FRANCONERI, Evanston, IL (US); Evan VLAHANDREAS, Winnetka, IL (US); Luke ARNOLD, Menlo Park, CA (US)

(73) Assignee: EXPERCEPTION LLC, EVANSTON, IL (US)

(21) Appl. No.: 19/263,025

(22) Filed: Jul. 8, 2025

Related U.S. Application Data
(60) Provisional application No. 63/668,638, filed on Jul. 8, 2024.

(51) Int. Cl. G06F 40/103; G06F 40/186

(52) U.S. Cl. CPC G06F 40/103; G06F 40/186

(57) ABSTRACT

A method and system for automatically generating a presentation output, such as a slide presentation. The method and system displays a user interface including a structured outline of a plurality of nodes. Outline node information, namely user textual input, is received from the user through the user interface to form a populated outline. A presentation output is automatically generated from the nodes of the populated outline. During outline construction, nodes can be added or moved by the user. Outline nodes to exhibit information can be included in the structured outline, whereby the outline node is displayed with the exhibit information in the presentation output. To generate the presentation output, groups of nodes are selected from the structured outline and compared to predetermined presentation templates, until a best template is determined for a presentation or a slide thereof.

### CROSS REFERENCE TO RELATED APPLICATION

The application claims the benefit of U.S. Provisional Patent Application, Ser. No. 63/668,638, filed on 8 Jul. 2024. The co-pending provisional application is hereby incorporated by reference herein in its entirety and is made a part hereof, including but not limited to those portions which specifically appear hereinafter.

### BACKGROUND OF THE INVENTION

This invention relates generally to creation of presentations, such as posters, slide show (e.g., PowerPoint®) presentations, or similar, and, more particularly, to a method and software-based system for assisting with presentation creation and layout.

People struggle with formulating effective presentations. The struggles occur both in the framing of a presentation (e.g., presenting an argument) and the layout of the created presentation points in the presentation display (e.g., poster or slideshow). There is a need for a tool to assist with creating presentations.

### SUMMARY OF THE INVENTION

The present invention, briefly stated, provides a tool for creating and editing presentations from a structured outline (a hierarchical tree of nodes containing points made in a presentation), exhibits, and data describing links between tree nodes and those exhibits. The outline tree nodes can consist of nodes that include parent nodes and child nodes. Parent nodes can summarize their one or more child nodes. Child nodes that are not parents of other nodes can be linked to an exhibit using linking data. Exhibits can comprise any of several data types, including but not limited to video, images, audio, lists, tables, charts, text, and other content. The linking data can include references to specific parts of the exhibit. The structured outline, child nodes structured to summarizing parent nodes, and exhibits or exhibit subsets linked to child nodes, is stored for the particular outline. The structured data can be exported into different presentation formats, for example readable prose text, a collapsible outline with inline exhibits, a node-line graph layout, a series of slides, an animated or scrolling presentation, a small one-page summary, a large poster, a rendering viewed in a 3D environment viewed in virtual or augmented reality, and other formats. When exported into any of these formats, a module selects subsets of nodes (and their linked exhibits), determines their spatial arrangement, and incorporates design considerations including the color, spacing, and font of the placed content, and other aspects of the exported format.

Embodiments of this invention include a recursive semantic summarization, particularly within nested spatial areas. It is generally understood that the typical human brain can only handle three new ideas at once, and that those ideas are better understood when they are prefaced by a high-level semantic summary of, or specification of the structure among, those lower-level details. Thus outlines of this invention desirably use recursive summarization or high-level structure specifications at every level. Embodiments of the invention replicate that structure in visual space. Each presentation slide typically represents up to 3-4 levels of an outline in their limited visual space, but for one-page presentation handouts that space might be 4-5 levels, and scientific posters could allow 8-10 levels or more.

The invention includes a method for automatically generating a presentation output. The method includes steps of: displaying a user interface including a structured outline of a plurality of nodes; receiving outline node information from the user through the user interface to form a populated outline; and automatically generating a presentation output from the nodes of the populated outline. In setting up the populated outline the user can add nodes and/or move nodes in the structured outline. In embodiments, an outline node can be linked to exhibit information in the structured outline, whereby the outline node is displayed with the exhibit information in the presentation output.

In embodiments, automatically generating the presentation includes converting the populated outline to an ordered node listing. This can be accomplished by generating a set of node ranges, for use in finding a best matching presentation template. Each node can be assigned an outline reference indicator, indicating the position in the outline (e.g., 1, 1.1, 2, 2.1, 2.2, etc.). Ranges of nodes can be compared to each of a predetermined templates, each template ranked relative to one or more ranges, and the highest scoring or best matching template used for that range of nodes. In embodiments, the system selects the final presentation template, or more than one template can be presented to the user for final decision.

In embodiments, automatically generating the presentation includes selecting a group of nodes from the structured outline and comparing the group of nodes to predetermined presentation templates, and automatically selecting and filling a presentation template with the corresponding outline node information for the selected group of nodes. Each of the predetermined presentation templates desirably, and independently, includes limits on content area, content amount, and/or content spacing. Selecting the presentation template can include identifying more than one presentation template that accommodates all nodes in the selected group of nodes.

For selection, more than one presentation template can be ranked relative to the selected group of nodes according to predetermined scoring rules as a function of spatial layout. The ranking can include applying template layout rules on content area, content amount, and/or content spacing.

In embodiments, the method includes automatically dividing the populated outline into independent sets of nodes. The independent sets of nodes are ordered to create an ordered list of nodes and generating the presentation output by comparing the independent sets of nodes to predetermined presentation templates.

The invention further includes encoded software instructions stored on a non-transitory computer-readable medium and executable by a processor of a host computer system to carry out the method. Any suitable computer system and/or network can be used for embodiments of this invention. Ideally, a user accesses the system over a network, such as through a cloud-based operation.

The system's encoded instructions can be executable to display a user interface including a structured outline of a plurality of nodes, wherein a user enters outline node information through the user interface to form a populated outline; and generate a presentation output from the nodes of the populated outline and the exhibit information. The encoded instructions allow for linking an outline node to exhibit information in the structured outline, and any other method steps discussed herein.

Other objects and advantages will be apparent to those skilled in the art from the following detailed description taken in conjunction with the appended claims and drawings.

### BRIEF DESCRIPTION OF THE DRAWINGS

FIG. 1 is a block diagram for generating a structured hierarchical outline and presentation.

FIG. 2 illustrates an application for generating a structured hierarchical outline and presentation.

FIG. 3 illustrates a method for generating a structured and hierarchical outline.

FIG. 4 illustrates a method for automatically generating a presentation based on a structured and hierarchical outline.

FIG. 5 illustrates an exemplary structured and hierarchical outline with an outline exhibit editing window.

FIG. 6 illustrates an exemplary structured and hierarchical outline with an outline details editing window.

FIG. 7 illustrates an exemplary presentation generated automatically from structured data within an outline.

FIG. 8 illustrates a method for automatically generating a presentation based on a structured and hierarchical outline.

FIG. 9 illustrates a method for automatically generating a presentation based on a structured and hierarchical outline.

FIG. 10 is a block diagram of a computing environment.

### DETAILED DESCRIPTION

The present technology, roughly described, provides a tool for creating and editing presentations from a structured outline (a hierarchical tree of nodes containing points made in a presentation), exhibits, and data describing links between tree nodes and those exhibits. The outline tree nodes can consist of nodes that include parent nodes and child nodes. Parent nodes can summarize their one or more child nodes. Child nodes that are not parents of other nodes can be linked to an exhibit using linking data. Exhibits can comprise any of several data types, including but not limited to video, images, audio, lists, tables, charts, text, and other content. The linking data can include references to specific parts of the exhibit. The structured outline, child nodes structured to summarizing parent nodes, and exhibits or exhibit subsets linked to child nodes, is stored for the particular outline. The structured data can be exported into different formats that can be presented to a recipient, for example readable prose text, a collapsible outline with inline exhibits, a node-link graph layout, a series of slides, an animated or scrolling presentation, a small one-page summary, a large poster, a rendering in a 3D environment viewed in virtual or augmented reality, and other formats (references to a presentation or other format herein are used for purposes of example, and not limiting the scope of the present technology). When exported into any of these formats, a module selects subsets of nodes (and their linked exhibits), determines their spatial arrangement, and incorporates design considerations including the color, spacing, and font of the placed content, and other aspects of the exported format.

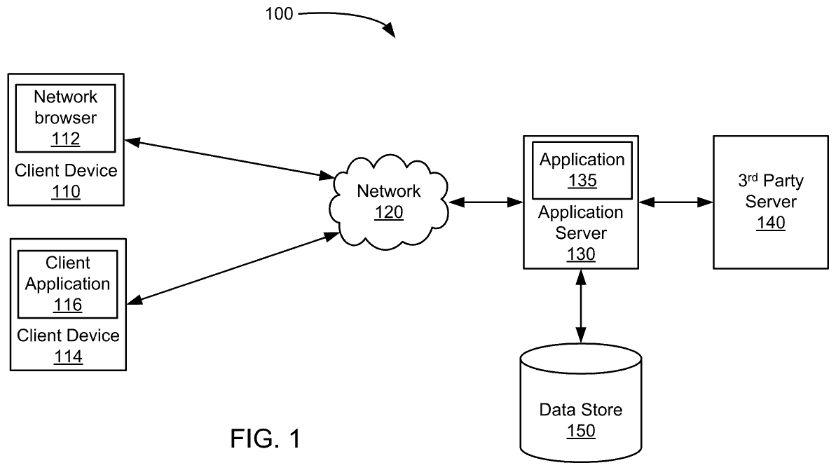

FIG. 1 is an exemplary block diagram for generating a structured hierarchical outline and presentation. System 100 of FIG. 1 includes client device 110, network browser 112, client devices 114 and 116, network 120, application server 130, application 135, third party server 140, and data store 150.

In some instances, the functionality described herein can be implemented at a client device by a network browser or a client application. Client device 110 may include a network browser 112 and communicate with application server 130 to utilize software or a software service provided by application server 130. A client device 110 may be a standalone device, for example a desktop computer, laptop computer, tablet, mobile device, or cellular phone, or in some instances may be implemented within an environment provided by a cloud computing service provider.

Network browser 110 can receive a content page and/or other content from one or more servers 130 and load the content page and/or content. The user can interact with the content page and/or content through the network browser, which can be updated based on user requests, code events, and other events. In some instances, the technology and functionality herein can be implemented all or in part by code loaded executed within a network browser.

Client device 114 can include a client application 116. Client application 116 can receive user input, communicate with application 135 on application server 130, and provide output to a user interacting with the device. Client application 116 can communicate with application server 130 and may generate a structured hierarchical outline from user input, automatically generate a presentation from the outline, and perform all or a portion of the functionality discussed herein.

Application server 130 may provide software, a software service, and/or otherwise communicate with network browser 112 and/or client application 116. In some instances, application server 130 can be implemented as one or more network servers and/or one or more application servers. Additionally, application server 130 can be implemented as one or more physical machines, logical servers, virtual servers, or other servers suitable for implementing the functionality discussed herein.

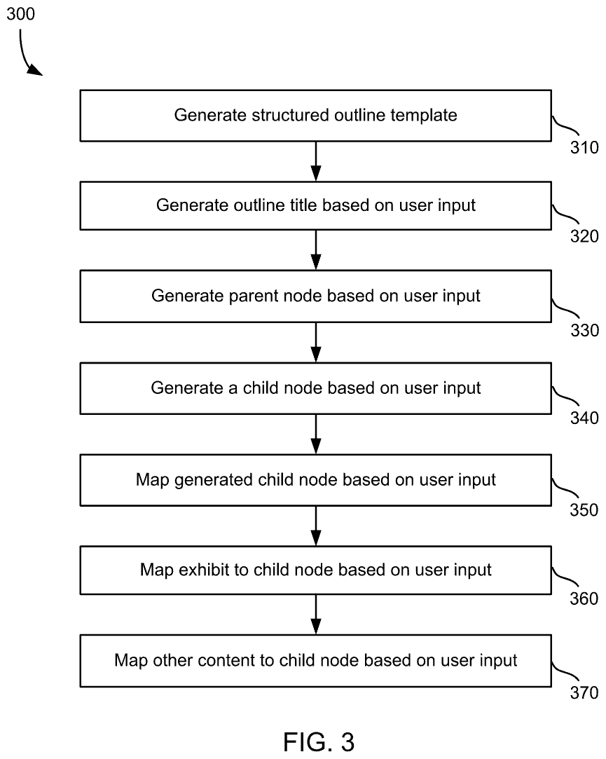

Application server 130 can include application 135. Application 135 may perform all or a portion of the functionality described herein, including but not limited to authenticate users, serve as an intermediary for storage and 3rd party services, serve software to the client device, generate a structured hierarchical outline, automatically generate a presentation from the outline, and perform other functionality. Application 135 can be implemented as a single application or a plurality of distributed applications. Application 135 is discussed in more detail with respect to FIG. 3.

The client device 110, application server 130, and other machines illustrated in FIG. 1 can communicate over network 120. Network 120 may include any private network, public network, the Internet, an intranet, a wide area network, a local area network, a cellular network, a Wi-Fi network, or any other network suitable for transmitting digital or analog data between two or more machines.

Third party server 140 may provide a service, file, or otherwise communicate with one or more of application 130 and client device 120. In some instances, third party server 140 can include a plurality of data files, such as for example images, dictionary data, and other content. The data files may be queried, retrieved, stored, and added to a structured outline by the present system.

In some instances, the third party server 140 may implement one or more machine learning models. The machine learning model may include one or more models or prediction engines that may receive an input, process the input, and provide an output based on the processing of the input. In some instances, a machine learning model implemented on third party server 140 may be implemented by a large language model, on one or more servers.

Data store 150 may include data that can be stored, retrieved, edited, and otherwise accessed and processed by application server 130. The data can include, for example, image data, mapping data, outline data, slide data, poster data, and other data generated or accessed by the present system.

In some instances, one or more of machines associated with 110, 130, 140 and 150 may be implemented in one or more cloud-based service providers, such as for example AWS by Amazon Inc, AZURE by Microsoft, GCP by Google, Inc., Kubernetes, or some other cloud based service provider.

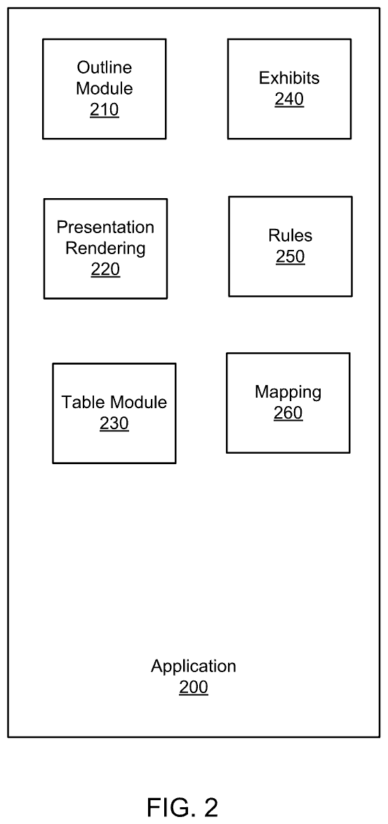

FIG. 2 illustrates an application for generating a structured hierarchical outline and presentation. Application 200 of FIG. 2 provides more detail for application 135 of FIG. 1. In some instances, all or part of the functionality described herein, including one or more modules of application 200, can be implemented in one or more content pages loaded into network browser 112. In some instances, all of part of the functionality described herein, including one or more modules of application 200, can be implemented by client application 116.

Application 200 includes outline module 210, rendering module 220, table module 230, exhibits 240, rules 250, mapping 260, and table module 270. Outline module 210 can manage aspects of outline generation and storage. For example, outline module 210 can create an outline, add exhibits to nodes, and other functionality related to outlines.

Rendering module 220 creates, stores, edits, and manages aspects of generating outputs in different formats from a structured hierarchical outline. The outputs can include but are not limited to readable prose text, a collapsible outline with inline exhibits, a series of slides, a scrolling interactive presentation on a mobile device, a large poster, a 3D environment viewed in virtual or augmented reality, and other formats.

In some instances, the present system can automatically generate output types in addition to slides, animated or scrolling presentations, small one-page summaries, large posters, and 3D environments viewed in virtual or augmented reality. For example, the present system can generate readable prose text, a collapsible outline with inline exhibits, and other content.

Table module 230 manages aspects of creating and storing tables. For example, table module 230 can automatically receive data and generate a table from the data. A generated table can include numerical data, charts and/or graphs, images, and other content. In some instances, tables can be managed and utilized as a type of exhibit.

In some instances, the table module 230 can be used to create a two-dimensional discrete table that can contain fields that can induce text, numbers, ratings, dates, times, and visualizations, which can be stored as records in each of those fields. Tables can also contain a specification for creating a visualization in two-dimensional continuous space, and other types of charts, visualizations, or diagrams. A table can contain fields that represent computations or relationships among other table fields, including sums, normalizations, string manipulations, formatting changes, or other computations or relationships. The table's discrete structure can be optimized to generate more effective presentations, based on rules that consider the links between an argument tree and exhibits. For example, a table exhibit can hide or de-emphasize fields or records that the hierarchical outline does not mention, or that a user or automated process determines is insufficiently important to include in a particular exported format. A table exhibit can cluster table fields, records, rows, or columns that the presentation generation module determines should be spatially grouped closer to each other within a rendered table. A table exhibit can sort rows, columns or fields, by the order that they appear in the outlined argument, or by order of importance for the argument.

Exhibits 240 can include content that can be added to a leaf node in an outline. In some instances, an exhibit can take the form of any of several types of media, including but not limited to an image, list, table, chart, graphics, text, video, audio file, or other media. Exhibits have metadata including a title, source, and alternative text intended for accessibility compliance (e.g., a screen reader). A user of the editor can link an exhibit to one or more leaf nodes within the structured hierarchical outline. The hierarchical tree, the exhibits, and links from the exhibits to particular nodes in the tree are all created and stored by the present system. An exhibit requires points to call out a subset of the relevant exhibit, which can include the entire exhibit. For a table, the link to the exhibit can correspond to the entire table, or a subset of row(s), column(s) or cell(s) in that table, or the entire table. For an image, the link to the exhibit can correspond to regions(s) of an image, or the entire image. For text, it can correspond to a substring of text, or all of the text. For media files, it can correspond to a particular frame range in a video, a playback range in audio, or some other subset or portion of a media file, or the entire file. The exhibits can be stored locally or remotely, created, edited, annotated, and/or retrieved.

Rules 250 can include business rules, outline content rules, outline hierarchical or structural rules, presentation generation rules, poster generation rules, and other rules. The rules for module 250 may include the rules as well as logic for implementing one or more rules.

Mapping module 260 can include the mapping or linking between elements of a structured outline. The elements can include exhibits and nodes including parent nodes and child nodes, and other elements. Mappings can be created, stored, and/or accessed by mapping module 260.

The modules illustrated in application 200 are one example of how an application may be structured to achieve the functionality described herein. Application 200 may include additional, fewer, and different modules, located on one or more servers in one or more platforms, to perform the functionality described herein.

The present technology provides a tool for generating an outline of structured data using a hierarchical tree and with exhibits. The hierarchical tree can include parent nodes and leaf nodes. Each node contains a ‘point’, a concise (typically 100-150 characters) sentence containing a single argument point intended to be made by a user, a shorter ‘stub’ or ‘topic’ (typically 3 words or under 25 characters) that summarizes that point and can be used in roadmap or agenda slides or consolidated versions of points for other contexts where more compact verbiage is desired. Nodes may contain other metadata including output formats, export preferences for that node and its subtree, user notes, and other metadata. Each leaf node (nodes that do not have children themselves) can be linked to one exhibit or a subset of that exhibit. Exhibits can take several forms, including an image, table, third party content (e.g., content retrieved from over a network). In some instances, an exhibit includes the content as discussed with respect to module 240 of FIG. 2, and can be governed by mapping module 260. The structured data of the outline can be used to generate various different forms of presentations.

Any parent node in the hierarchical tree can be considered a summary node, or summary point, which summarizes its child nodes and/or specifies relationships among those child nodes. A parent node has child roles that can structure thinking and can affect the automated generation of output formats including but not limited to presentations. Any parent node can also have a summary point type that can provide formal specification of factors that can structure relationships among the first, second, third, or subsequent child points, and can specify the logical or rhetorical purpose of a set of child points. These summary types can be organized into subtypes that can include unordered, ordered, or roles. Unordered subtypes can include Examples, Problems, Reasons, Conclusions, Recommendations, Causes, Effects, Divisions into Parts, and Comparisons. Ordered subtypes can include Chronology, Steps-in-process, Rank (Best to Worst), and Rank (Worst to Best). Role subtypes can include Goal-Problem-Solution (a goal, a problem, and a solution or next step toward a solution), A-But-B-Therefore (A, B, and a conclusion), Cause and Effect (cause, effect, justification), Deductive Inference (a major premise, a minor premise, and a conclusion), Inductive Inference (a conclusion followed by a reason or reasons), Generalization From Examples (an example or examples, a generalization, and a justification for the generalization), Application from Generalization (a generalization, its proposed application, and a justification for the application), or Parallel Structure (an explicit recognition of similar roles among ‘grandchild’ nodes among multiple ‘parent’ nodes underneath the ‘grandparent’ node typed as having Parallel Structure).

Some summary point types can affect recommendations to users that prompt them to improve the quality of their presentation by more accurately following prescriptions for sound logic and reasoning. Some types can also create a structured representation of the summary point's logical goal within the argument that can serve as input to other processes that can offer automated suggestions for improvement of that logic (e.g., prompts and responses to and from a Large Language Model). For example, Cause and Effect type can specify a cause, followed by a proposed effect, followed by a justification for why the causal connection is logically sound. A Deductive Inference Type can specify a major premise, a minor premise, and a conclusion that combines those two premises. An Inductive Inference type can specify a conclusion followed by a reason or reasons for that conclusion. A Generalization From Examples Type can specify an example or examples, a generalization from those examples, and a justification of whether those examples constitute a representative sample of a population, in addition to a specification of the applicability of that generalization to various contexts). An Application from Generalization Type can specify a generalization, its proposed application, and a justification of why the application fits within the context of the generalization.

Some summary point types can affect the modules that generates a presentation from the outline, exhibits, and the links between them, by generating either discrete rules or decision weighting constraints within the presentation generation module. Some summary point types, including Division-Into-Parts, Comparison, Goal-Problem-Solution, Deductive Inference, Generalization From Examples, and Application from Generalization, can increase the probability that their child points are displayed simultaneously and/or nearby in space. This effect can include appearing on the same slide in a slideshow or scrolling interactive presentation, or appearing near each other in a large scientific poster or small one-page summary document. Some summary point types can increase the probability that child points are shown sequentially and/or far from each other in space, including showing the Example type as a series of sequential examples, instead of potentially overwhelming a viewer with simultaneous presentation. Some summary point types, including Goal Problem Solution or A-But-B, can be linked to rules that increase the probability that child points are shown as the root of a new slide or spatial region. Some summary point types, including Conclusions, Chronology, Steps-in-a-process, and Ranks, can be linked to rules that increase the probability that child points are shown simultaneously in one global slide, image, or spatial region after they have been individually presented,

Summary point types can imply rules for how presentations should be styled. Some summary point types, including Chronology, Steps-in-a-process, or Ranks, can increase the probability that child points are shown as a timeline or in numbered lists. Some summary point types, including A-But-B, can imply rules for how text should be rendered such as printing the word ‘But’ in bold.

One Ordered Summary point type, Parallel Structure, can specify links among grandchild nodes of the same type, that each descend from its child nodes. For example, if a Summary point with Parallel Structure as its type contained 2 or 3 child folders, each of the type Goal-Problem-Solution, then the presentation module can render those grandchild points as a single table layout, aligning the Goals, Problems and Solutions of the grandchild nodes in a single table layout that makes the similarity of their types visually explicit. For example, the layout can include spatially aligning the 2 or 3 grandchild points of type ‘Goal’ as a single row (or column), ‘Problem’ as a single row (or column), and ‘Solution’ as a single row (or column).

In some instances, a summary point or parent node can have three child nodes or leaf nodes. A child node or leaf node is a point and can include child roles. Leaf nodes can make callout links to exhibits which are associated with the particular leaf node.

An outline can be generated by an outline editor. The outline editor can receive user input to create an outline title (which can be a summary sentence that summarizes the entire tree), one or more parent nodes, and one or more leaf nodes that do not have children themselves. The user input can be in the form of typed text, pasted text, text automatically generated by the software based on other text, input, or other content, or text automatically produced by processing user-submitted or other files containing relevant text. The outline editor can receive text input for the outline, parent nodes and child nodes, and may receive non-textual input that maps exhibits (or subsets of exhibits) to the points made by any leaf node. The outline editor generates the outline as structured data in the form of a tree, based on input that is typed, pasted, imported from other user files, generated by a suitable software module, or obtained from other sources, such that the structure is formed by the child nodes corresponding to particular parent nodes, with exhibits linked to one or more leaf nodes. Tree structures are constrained definitionally by the rule that each node must have exactly one parent node, placing a constraint on the outline's format. In contrast, a user might desire to include a subset of nodes in multiple locations in an outline, for example to include an explanation for a type of analysis in each outline location where that analysis is used. Nodes can therefore also contain hyperlinks between themselves and other nodes, allowing more flexibility in the outline structure than is prescribed by a strict tree structure.

In some instances, the present system can make suggestions based on knowledge of the linked exhibits and structured data content. For example, if an exhibit is referenced two or more times by multiple nodes in the outline, the present system may suggest whether the nodes should be clustered closer together in the hierarchical outline, which for example could help ensure that those the content of those two nodes is more likely to be placed closer together in a spatial area within a presentation Additionally, if two columns of a table are linked to nodes in the outline, the system may query as to whether the other columns are all necessary or can be omitted or summarized to help focus a viewer on the information contained in the linked columns.

The structured data in outline form can be automatically exported into alternate formats, including presentations, which utilize the structured data provided by the editor and its links to the exhibits. Examples of alternate formats include readable prose text, a collapsible outline with embedded exhibits, a node-link graph layout, a series of slides, a small one-page summary handout, a large poster, or a rendering in a 3D environment viewed in virtual or augmented reality, and other formats. The exported formats can have a user-specified level of detail provided in the presentation, by varying what is exported into a given version of a presentation, including the rendered depth or chosen subsets of the tree, and what linked exhibits to show, and at what detail level to show them.

Each format type can rely on a set of automated rules intended to ensure that presentations require minimal cognitive effort to understand, guide viewers with graph design principles, and appear professional, trustworthy, and aesthetically pleasing. The automated rules can include a layout module that performs several functions. For example, the layout module can keep information from nodes that are nearby each other in the tree as nearby in space and time in any exported format (e.g., for slides, putting node information into the same slide). The layout module can also keep node text close to the exhibits that they are linked to, and to use arrows, outline shapes, or color highlighting to clarify which exhibits and subsets of exhibits are linked to those nodes. Additionally, the layout module can control the way that color is used in the exported format, restricting the use of color in node fields (e.g., point text) and exhibits (e.g., visualizations and charts), to ensure that displayed colors are used in semantically clear and consistent ways. The layout module can also automate graphic design principles, including using predefined templates for exported formats and rely on a minimal color palette, omit unnecessary visual elements that can be perceived as clutter (e.g., boxes, lines, patterns, and gridlines), ensuring that edges of rendered objects are ‘aligned’ such that extrapolations of those edges would tend to meet in both position and angle, and by allocating more blank ‘negative space’ among spatial sections in ways that are monotonically larger for nodes that are farther in depth and/or breadth in the hierarchical outline. The layout module can automate graphic design principles that guide a user's eye through visual elements in a sequence that is related to the hierarchical position of elements in the outline tree, using cues including visual salience cues such as font size, bold text or unique colors, and left-to-right and top-to-bottom spatial ordering and animation over time.

The outline module can incorporate automated advice intended to lead users to create clearer presentations for audiences. Node point text can be restricted to a maximum number of characters (e.g., 150) to ensure that an argument's structure can be captured by the outline, instead of leaving that structure implicit within a block of prose. Users can be instructed to write node point text using language that can include being concise, concrete, specific, and/or in the form of an active demonstrative sentence (e.g., “Sales have increased since 2022”) as opposed to simple naming a topic (e.g., “Sales Analysis”). Automated systems (algorithmic, machine learning, and Large Language Models) can prompt users to follow such rules, or provide suggested revisions or rough drafts for node points or stubs. The application can also automatically suggest exporting only the first N levels of the outline tree, or some other subset based on other rules, to an exported format like a presentation, leaving lower detailed levels hidden or available only on-demand for an audience.

The structured data representation can be used to generate presentations that meet accessibility guidelines, including alternative text for images, minimum font sizes, and minimum color contrast thresholds.

FIG. 3 illustrates a method 300 for generating a structured and hierarchical outline. The method of FIG. 3 can be implemented at least in part by any content pages loaded into network browser 112, client application 116, and/or application 135 of FIG. 1. Although the method 300 is shown in linear layout, it is to be understood that steps can be repeated, and that the method is desirably recursive in nature. A structured outline template may be generated at step 310. Upon receiving input to generate a new outline, the present system can generate an outline template. The template may provide for mappings between parent nodes and child nodes, linking or mappings between a child node and an exhibit, and other elements. The template may be selected from a plurality of predetermined templates.

The outline title can be generated based on user input at step 320. The title can be received as input from a user and stored in association with the outline.

A parent node can be created at step 330. The parent node can be created to include textual content that is received from a user. A child node is generated from user input at step 340. Each generated child node is mapped to a specific parent node (at step 350). In some instances, a parent node can have a plurality of child nodes, for example, without limitation, three child nodes. Each child node can be created to include textual content and be mapped to an exhibit. Child nodes can also store data related to user preferences about how to render its descendant tree in presentations, such as starting a new slide in a slide show, hiding the entire subtree in an exported format, or showing that node alone on a slide or other spatial region of an exported format.

An exhibit, such as for example an image, text graphic, table, or other exhibit discussed herein, may be mapped to a child node at step 360. The system may receive input from a user to add the exhibit (e.g., image) to a child node. The exhibit may be represented in the outline by a graphical icon representing the particular exhibit, and may be viewed upon selection from a user viewing the outline.

Other content may be mapped to a child node at step 370. The other content can include content retrieved from a remote server, such as for example dictionary data from a dictionary network server, text rephrasing via a prompt and response from a Large Language Model or other machine learning or algorithmic system for improving the quality, length, clarity or precision of written text. Any content may be retrieved from a remote server in response to a request from a user, and the retrieved content can be added to an outline.

The order of the steps in FIG. 3 are exemplary, and it should be understood that the steps in FIG. 3 can be performed in an order other than that in which they are displayed.

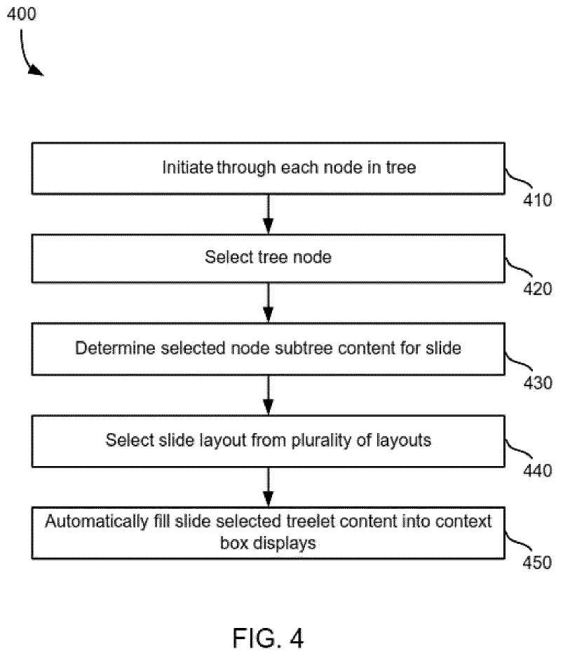

FIG. 4 illustrates a method, according to embodiments of this invention, for automatically generating a presentation based on the structure specified by the hierarchical outline, exhibits, and the links among them. The method of FIG. 4 discusses automatically generating a presentation for purposes of example only. It should be understood that other output formats can be generated automatically as well, including but not limited to a small one-page summary handout, a node-link graph layout, a large poster, a rendering in a 3D environment viewed in virtual or augmented reality, and other formats. First, a search is initiated through each node in the hierarchical tree with the intent of packing content into a local spatial area of a presentation based on a set of layout templates. Layout templates can include discrete ‘slots’ intended to fit the text from a single node or N nodes, or continuous areas that can be allocated to fit content based on estimated render sizes of mixtures of exhibits and text. The packing module can follow rules about which tree subsets are most important to render nearby in space or time (e.g., for a slide presentation, on the same slide). Exported presentations can be limited to a subset of nodes and linked exhibit content that a user or other module determines should be included in an exported presentation. The tree traversal module can be structured around an ordered search across those nodes (including their linked exhibit content) intended for export, and at each node the system can iteratively identify the subset of layout templates which could fit that node, a subset of its descendants, and their linked exhibit content. The module can then continue this process of fitting such tree subsets into layout templates until every node and linked exhibit in the tree has been included in at least one layout template. In some instances, the tree traversal module can start at the top of the tree (where the ‘summary’ points tend to be clustered), fitting groups of nodes into layout templates in several passes from the top-down. In other instances, the tree traversal module can start at the bottom of the tree (where the ‘leaf’ points tend to be clustered), fitting groups of nodes into layout templates in several passes from the bottom-up. This group fitting process can stop when it reaches the top or bottom of the tree, and it can also stop after reaching a predetermined level of the tree (e.g., level 3) where other content-packing rules may apply. Different search orderings can also be combined, for example by fitting groups of nodes into layout templates from the top-down and bottom-up simultaneously and meeting in the middle.

In some instances, a number of switches, set automatically by the software or manually by the user, may be used to affect the module that translates the combination of the outline tree, the exhibits, and their mappings, to presentations. For example, three switches that can be used in the module can include a HideInPresentation, StartNewSlide, Revisit, and PreviewDetails. The HideInPresentation switch removes the node and its descendants from a presentation, and can also allow that hidden content to be rendered in real-time in response to user requests which can include selecting the parent of the hidden parent node from a rendered presentation, a rendered outline, or in response to other analyses (e.g., interpretation of audience questions input via typed text or speech recognition) that suggest unhiding node hierarchies that might be newly relevant (e.g., to answer an audience question). When the StartNewSlide switch is engaged for a node, it ensures that the node is displayed as the ‘root node’ in the tree selection module. For a slide or animated sequence, this can mean that a node will not appear as a ‘child’ in its parent's slide or subset of a sequence. For a poster, this can mean that a node should be placed in a new spatial area and rendered in a manner that indicates that its summary point is the most important of its descendants (e.g., by rendering it in a relatively large font). The Revisit switch can have 3 level values: off, 1 level, and 2 levels. When a node has a Revisit level of 1 or 2, the module can insert a slide for that node after each of its child subtrees have been exhausted, including N levels of detail on that subtree. For example, a Revisit level of 2 can result in these “reminder” slides (or frames in an animated sequence) showing the point text for the node's children and grandchildren that have already been shown. This switch enables nodes to act as ‘roadmap’ markers in a presentation, reminding viewers of previously shown content. The PreviewDetails can show a preview of node descendants that will later be shown on their own slides, and the level of that preview can be specified similarly to the Revisit level (off, 1 level down, 2 levels down).

A tree node is selected at step 420. Once a node has been selected by the tree traversal, it is passed to the content packing module, which is responsible for selecting how much of the node's subtree can be fit into a layout specification for a spatial area of a presentation (e.g., a slide in slide show, a frame in an animated sequence, a spatial area in a poster or region of space in an augmented or virtual reality rendering) at step 430. The module then attempts to fill the layout specification with the selected node's descendants (including node text and exhibits) in a similar search. To preserve the sequential order prescribed by the outline's tree, if the module encounters a branch of the node's subtree that is more than N levels deep, it terminates packing early, and only shows those N levels. As examples, for animated sequences this level might typically have a parameter of a maximum of 3 levels, for slides, 4 levels, and for posters, the entire outline hierarchy is shown such that N equals the remaining number of levels descended from the presently considered node.

In some instances, additional switches can be used for additional effects on slide packing. Examples of additional packing effect slides include a Revisit level switch and PreviewDetails level switch. On subsequent displays of a node's “reminder” slide (as invoked by a Revisit level switch), the slide shows progressively more child subtrees, effectively limiting the slide to the first N children (where N is the number of times that the node has been revisited). The PreviewLevel switch has the same values of off, 1 level, or 2 levels, and when it has a value of 1 or 2, the slide abandons the packing approach used to show those nodes later in a presentation and instead displays all the text of node points (with no exhibits) of the next N levels.

In order to determine what content will be able to fit into a presentation Layout, the presentation packing module has a concept of layout template ‘fullness’, and can iteratively fill up the Layout until it has reached some maximum capacity. It can also attempt to fit an entire subtree into a Layout at once, and reject the Layout for that subtree if the content overflows. Users can specify whether Layouts contain a combination of areas that fit discrete ‘slots’ (e.g., an area known to display the text associated with one node, or a certain number of nodes, or a text exhibit of less than a threshold number of characters, an image of a user-defined preferred render size, or a table exhibit of a designated number of rows and columns). Layouts can also contain continuous areas that can fit a maximum amount of content based on estimated size needed to render mixtures of exhibits and text within the constraints the ordering of nodes in the outline (which can be rendered in orderings including left-to-right or top-to-bottom) as well as design factors such as readability and aesthetics. Exhibits can be marked as requiring areas of a certain size with discrete categories (e.g., images can have a user-specified intent to be viewed as currently stratified into Tiny, Small, Medium, or Large), or automated rules can determine minimum continuous display areas needed to display a text exhibit (e.g., characters per unit area) or table (e.g., number or rows or columns that must be displayed). A summary node (with children) counts as “contained” if a non-preview Layout displays its point text at the Child level. A point node (no children) counts as “contained” if a non-preview slide displays its point text and Exhibit, if any.

In addition to these high-level control flows, there are a number of more granular constraints on slide packing. First, unless specified by a PreviewDetails switch, points must be shown with their exhibits, and if both cannot fit in a layout template (e.g., a slide in a slideshow), then it must be shown in another slide that contains sufficient space. Second, if two or more adjacent child “families” (either children or grandchildren) point to the same exhibit, then the module can display that exhibit once, if multiple children can be presented with it simultaneously. There can be additional rules including specifications for including previously shown parent node text in order to provide historical context for currently rendered descendants.

Once a group of nodes is selected, the slide layout module selects the most suitable layout from a number of predetermined layouts at step 440. Once the most suitable layout is selected, the system then adaptively populates the slide at step 450 by filling all of the slots in the layout with the corresponding node content.

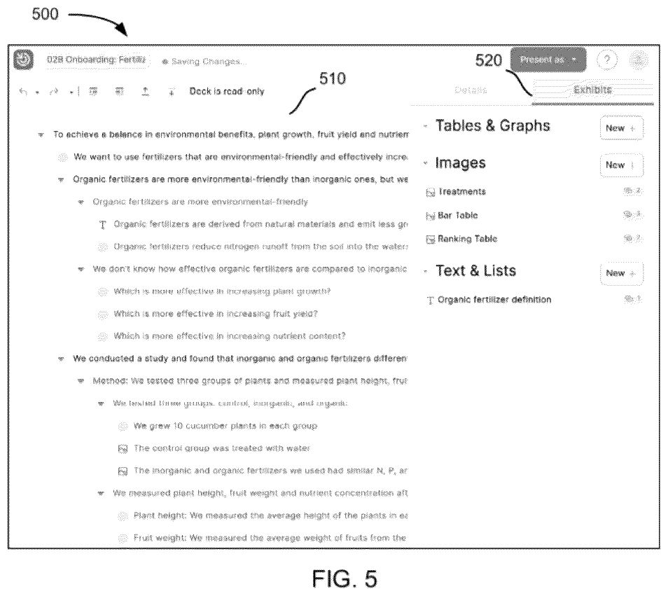

FIG. 5 illustrates an exemplary structured and hierarchical outline with an exhibit editing window, as provided through an editor interface. The interface 500 includes an outline section 510 on the left side and an exhibit portion 520 on the right side. The outline section includes an outline with a root node, parent nodes and child nodes. Each parent node in the outline can be collapsed by selecting the arrow icon in front of the parent node. Each parent node typically includes one, two or three child nodes, but can include more. Leaf nodes that are not parents of other nodes can be associated with an exhibit, as indicated by the exhibit icons to the left of each relevant leaf node.

The exhibit portion of the interface includes collapsible sections for different types of exhibits. Exemplary displayed exhibits include tables and graphs, images, and text and lists. Each exhibit type can include a collapsible or sortable menu of the particular exhibits of that type, and a selectable icon for adding a new exhibit of the particular exhibit type. For example, in the images portion of the exhibits displayed in FIG. 5, there are three illustrated images.

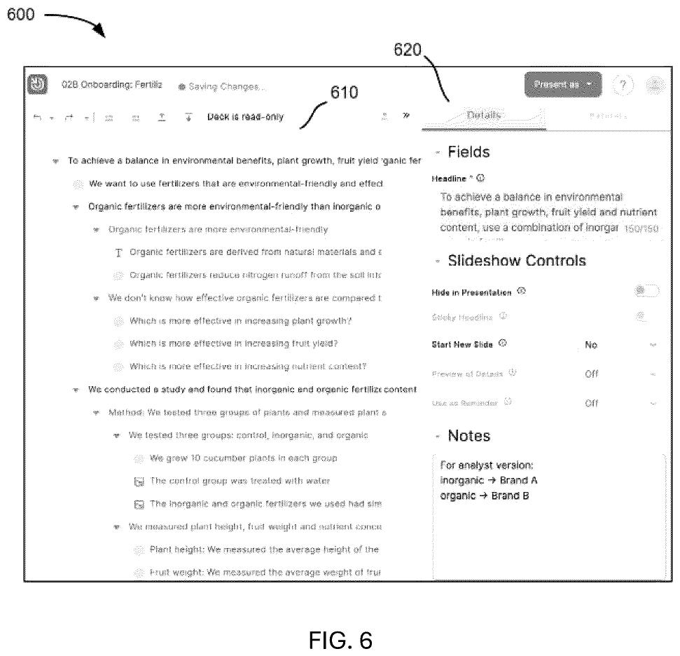

FIG. 6 illustrates an exemplary structured and hierarchical outline with an outline details editing window. The interface 600 includes an outline section 610 on the left side and a “details” portion 620 on the right side. Similar to FIG. 5, the outline section includes an outline with a root node, parent nodes and child nodes.

The details portion of the interface includes collapsible sections for aspects of a node that can be configured. Exemplary configurable parameters for a selected node include editable text, slideshow controls, and notes. The fields parameter allows a user to create and edit a headline for the selected node. The slideshow controls allow a user to specify how the selected node can be handled or used in a slideshow that can be automatically created from the outline. The notes parameter allows a user to enter a note for the particular node. Note that other detail parameters may be implemented for an outline node, including parameters for other output formats described herein.

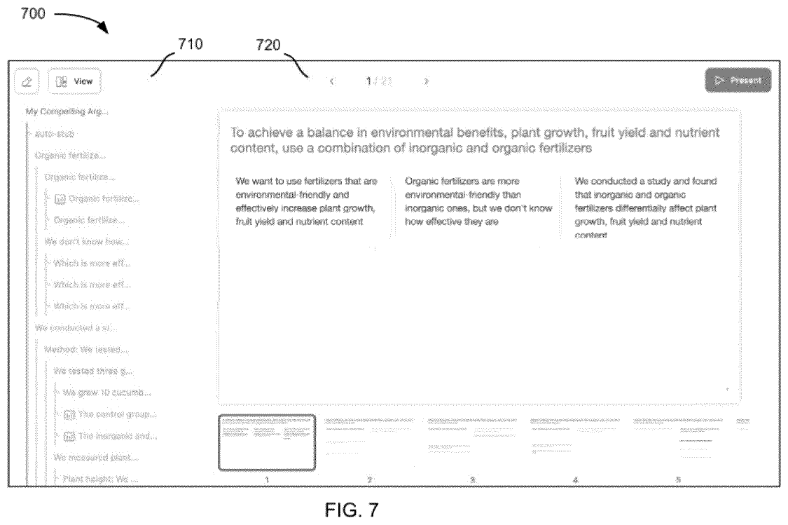

FIG. 7 illustrates an exemplary presentation generated automatically from structured data within an outline. The presentation interface 700 of FIG. 7 includes an outline selection portion 710 and a slides portion 720. The outline selection portion at left illustrates the outline from which the slides are generated. The outline is selectable to allow a user to see what slide or slides are generated from which structured data portions of the outline. For example, a particular slide may be generated from multiple child nodes structured under a particular parent node. The slides portion illustrates a slide generated from the selected outline portion, automatically generated based on rules followed by the present system to generate the particular slide.

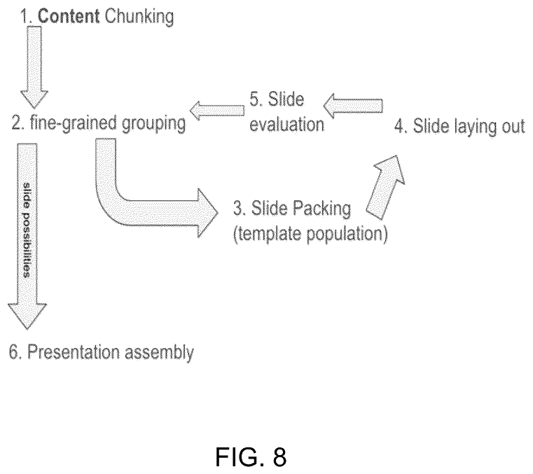

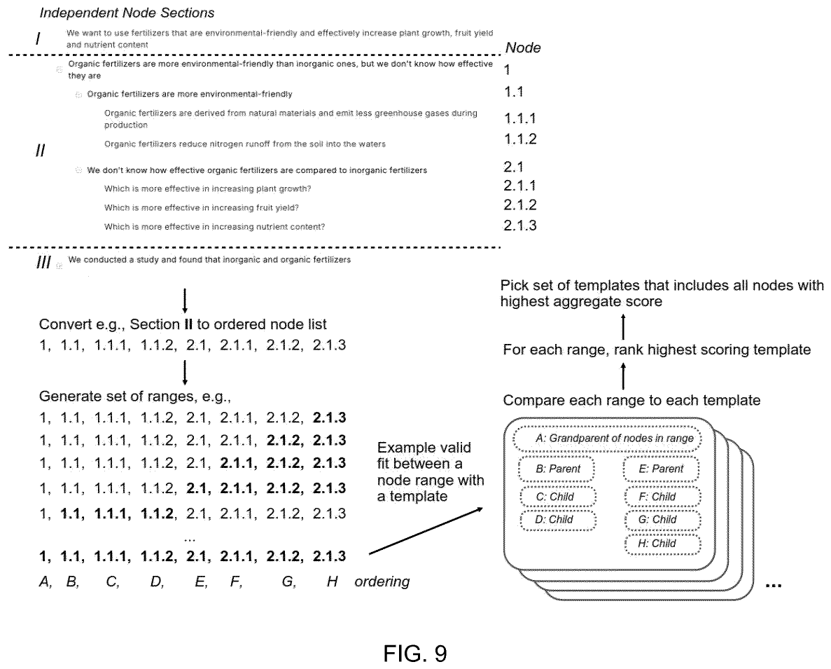

FIG. 8 shows another illustration of automatically organizing nodes into templates for presentation preparation. FIG. 9 shows more details of such implementation.

The node outline tree, such as shown in FIG. 5, can be split into sections of independent sets of nodes that can be independently translated into a set of spatial layouts. Each section can be converted into an ordered list of nodes. A set of seed nodes can be chosen from that list, each of which can be expanded into a range of nodes from the list that includes that seed node, which can be referred to as a range of nodes. A range is valid if the nodes can be packed (see FIG. 9) into at least one of a set of layout templates that each specify how those nodes (and any linked exhibits) can be laid out in a local spatial area. For each valid template for each range, a set of template scoring rules can be used to evaluate the slides, such as by ranking the relative desirability of that template for that range. A set of valid possible ranges based on a given seed node can be expanded to include more ranges based on that seed, by picking an existing range and expanding its range of nodes by repeatedly applying a range expansion module. After generating a set of ranges from each seed node within a section, a separate step can enumerate the set of all combinations of ranges that includes all nodes in the ordered list. That step can also compute an aggregated score across the highest-scoring spatial layout template for each range within each of those combinations. This process can produce one set of layout templates (for example, a slideshow, or a poster) for a section, which can be combined with the output of similar processes over each of the other sections. The process of choosing subsets of nodes to be matched against the spatial areas within a template does not strictly require generating ranges of ordered list of nodes, and could instead match the structure of the outline tree, and the content of the nodes and their linked exhibits, to templates via other methods

In embodiments, the node outline tree can be split into independent sets of nodes, which can be referred to as outline sections, according to a set of rules. The rules for determining the locations of the splits in the tree can include user-defined breakpoints (e.g., a user setting a node property ‘by hand’ to signal an intention to start a new slide), semantic properties of a node (e.g., node types, tags, or other metadata added by the user, or other automated rules, or properties of the shape of the outline hierarchy (e.g., splitting between two nodes when the difference between their depths in the tree is greater than some value). A summary can provide formal specification of factors that can structure relationships among the first, second, third, or subsequent child points, and can specify the logical or rhetorical purpose of a set of child points. This step can aid separating outline content into smaller sections that can be processed independently, which can reduce the amount of computation required to find preferred mappings from sets of nodes to a set of spatial layout templates. These sets of nodes are often subtrees within the broader outline trec, but they can also be any set of nodes that are intended to be transformed into an independent section of content within a presentation. These sections need not be mutually exclusive. As one example, a set of nodes at the second and third level of the tree can be transformed into a slide, or set of slides, that provide a high level ‘roadmap’ of a presentation. These same nodes can also be included in other sections when that content should be repeated in other areas of a presentation (e.g., as a preface for showing information from the nodes at the fourth and fifth level of the outline).

Each outline section can be converted into an ordered list of nodes. This conversion can be based on a depth-first traversal, breadth first traversal, or another method. This ordered list can be processed into a set of non-mutually-exclusive ranges of node indices (and their associated content, for example links to exhibits), according to a set of rules, such as described below.

Each range can be tested for compatibility with a set of layout templates that are selected as valid templates for a given type of presentation. These templates specify how nodes (and their linked exhibits) could be laid out in space across progressively smaller nested spatial content areas, which in many cases can be rectangles. Templates can contain a tree structure of a set of content areas (e.g., see rectangular areas in FIG. 7 and FIG. 9), each with an ordering specification that can be potentially matched with a range in an ordered node list, a content display specification (e.g., show text in a given font size or color, a position specification relative to the parent's content area, and a content specification that restricts what can be placed in that spatial content area.

The template position specification can include the complete boundaries of a spatial area, or only partial specifications. For the case of rectangular spatial areas, the specification could be for all four sides of the rectangle relative to the parent rectangle, or only a subset of that information. For example, it could specify the top and/or left bounds, leaving the right and/or bottom bounds flexible to fit needed node text and/or exhibits, to occupy a given percentage of space, to allow more or less space for other rectangles based on their content, or to move the edges of some rectangles to align them to the edges of other rectangles. Templates can also have rules that specify spacing among elements, for example adding a given amount of blank space between the first and second row of a layout. In embodiments, each of the templates has a different configuration, such as, without limitation, different configurations of spatial content areas (e.g., size, placement, number, etc.), and/or different spacing rules. Alternatively, the templates can be automatically constructed as needed following predetermined rules, as a function of the provided nodes.

The template content specification can include nodes with particular types of metadata (e.g., a minimum or maximum amount of text, of a given summary type, or in a particular relative location in the entire outline tree, or the subset of the tree spanned by a particular ordered node list). That content specification can include nodes linked to particular kinds of exhibits (e.g., a node with a link to an image) with particular types of metadata (e.g., an image of a given size or aspect ratio), and whether that exhibit is intended to be placed in the same spatial content area, or another nearby area.

As an example, assuming rectangular spatial content areas, one simple template could specify two content areas, stacked on top of each other as rows that take the full width of a parent rectangle, except for five pixels of buffer area on the left and right. The first row's content specification could require a summary node, and the second row's content specification could require a child node relative to that summary code, and one that is linked to an image exhibit. The second row's content specification could also include a set of templates that allow flexible spatial arrangements of the node's text and its linked exhibit, with one template placing the node's text in a row above a row for the exhibit, or another that specifies its node text in a column to the right of a linked exhibit column.

The process of mapping nodes to templates can allow the abstract hierarchy of the presentation outline to be mapped to a spatial hierarchy of progressively smaller content areas within a presentation. This mapping can help ensure that higher level nodes tend to be mapped to spatial areas that are on the top, or to the left, or in a larger or bolder font, compared to lower level nodes, increasing the probability that they are inspected by a viewer before lower-level nodes. Likewise, this mapping can help ensure that relatively lower-level nodes tend to be mapped to smaller content areas that tend to be spatially placed lower, or farther to the right, or in smaller or lighter font, increasing the probability that they are inspected by viewer after the content of higher-level nodes. The example in FIG. 9 depicts a simple template that could specify content areas for three relative outline levels of nodes. It specifies a content area for a range's highest level node at the top of a spatial area, two lower level-nodes underneath that node, and 2-3 lowest-level nodes progressively underneath those, allowing a depiction of the structure of the outline's hierarchy to be mapped to the template's spatial layout in a way that leverages a typical viewer's bias to inspect displays starting with the top and left, and/or larger or bolder fonts, to increase the probability that a viewer inspects that node content in a given order. A template can specify any number of such levels among its content areas.

Another method for mapping the abstract hierarchy of the presentation outline to a spatial hierarchy is to allow template content areas to specify possible sets of other templates, allowing templates to be applied recursively. This method can be especially useful when creating large layouts that map many levels of outline hierarchy, such as a single scientific poster that is several feet in width, which can contain an entire presentation.

If a tested set of content (e.g., a range of nodes and linked exhibits) cannot satisfy the layout template's requirements, or cannot accommodate all elements in a set of content, the template may be rejected for that set of content.

Once a template is validly matched to an ordered set of nodes, a layout optimization module can then modify the spatial positions of the boundaries among content units In some cases, the module can begin with known constraints such as a boundary, height, width, or aspect ratio of a spatial area (such as a fixed-size outer spatial boundary within a slide, or an area allocated for title, authors, and affiliations in a scientific poster), iteratively addressing the layout constraints specified in the template until the size, position, and styling of all elements are statically defined. Each template can contain a respective set of allowable variations in column widths and row heights, enabling flexibility in how components are arranged. These variations can help accommodate differences in node text length, exhibit size, and the number or complexity of linked exhibits associated with each node.

For each template that fits a given range, a set of template scoring rules can be used to rank the desirability of the mapping between a range and a given layout template. These scores can evaluate metrics such as information density (e.g., how many nodes were packed per template), distribution of blank space (e.g., whether a layout is ‘lopsided’ horizontally or vertically), spatial alignment (e.g., of object edges within a local spatial area), or whether blocks of text are enclosed in regions of desired sizes (e.g., not too small for legibility or ideal exhibit sizing), or aspect ratios (e.g., not too narrow for legibility or ideal exhibit sizing). Some scores can also produce categorical outputs, such as whether content overflows. Each rule can produce a desirability value on a scale, which can subsequently be normalized or transformed, and finally aggregated (i.e., a weighted average) into a single score for that mapping between a range and a spatial layout template. In some cases, these scores could be used to generate hypothetical ranges that do not exist in an ordered list, but if they did, they would lead to a relatively high-scoring spatial layout template mapping. If so, a user could be notified in the outline editor that, if their outline structure were changed, the presentation creation module could produce a match to a layout template that would result in a higher quality presentation.

There are multiple ways to produce a set of ranges of node indices that would be subsequently tested for compatibility with appropriate layout templates. In some cases, the method can be to test the set of all possible ranges within each section. Another method is to choose a subset of seed nodes according to some rule, and expand each of those nodes into ranges of indices around those seed nodes within the ordered nodes. That rule can include sampling nodes based on some property that can include their depth in the outline tree (e.g., starting with nodes in the ordered list that are at the highest or lowest level of that section of outline), their semantic content (e.g., nodes of a certain type such as leaf nodes linked to exhibits, or to particular types of exhibits), or being linked to the same or different exhibits as other nodes. In other cases, the ranges can be seeded iteratively by basing selection off of the results of previous iterations. For example, seeds could be iteratively picked by starting with the node in the ordered list that has the deepest level in its outline tree section, but has not yet been included in another range.

For the possible set of ranges that contain a given seed node, there are a subset of possible ranges around that seed that can produce a valid mapping to a set of layout templates that are appropriate for a given type of presentation. That set can be expanded to include more ranges based on that seed, with one method being picking an existing range and expanding its range of nodes by repeatedly applying a range expansion module. That module can attempt to grow an existing range to include adjacent indices in the ordered node list, to test whether that range (and its linked content, e.g., exhibits) can satisfy the requirements of packing a spatial layout template. In some cases, the module can expand an existing range by including one or more nodes at the border of the existing range within the ordered list of indices, either forward, backwards, or in both directions in that list, based on a set of rules. Those rules can include expansion that adds nodes that are semantically similar in their content to the existing range, do or do not contain links to particular kinds of exhibits, contain links to exhibits that are already linked within the existing range, or have more or less desirable relationships to the nodes in the current range within the outline tree (e.g., expanding an edge of a range to include a child node of the node at one edge instead of expanding to include a parent node of the node at the opposite edge) compared to the existing range.

If a given range cannot be packed into any of the available layout templates, it can be recorded as a failure. After a failure, the range expansion module can continue to expand in the same direction, or opposite direction, or if a set of rules are satisfied, it can terminate the process of adding new ranges to a current set of ranges. These rules can include a maximum number of failures, a maximum number of ranges, some property of the nodes within a range (i.e., spanning a certain number of levels in the tree), or a maximum range size

After generating a set of valid ranges within each section, a separate step can enumerate a set of all ranges that include all node indices in a given section's ordered list, to create a set of possible presentations. In some cases that set can also contain duplicates of nodes indices, for example when providing a presentation overview based on higher-level nodes in the outline tree, before redisplaying those same nodes later in a slide presentation. A separate step can then compute an aggregated score for each presentation, in order to produce a ranking of those that are most likely to be considered effective. This step can then include aggregating scores of a set of separate layout templates that capture the required content. For a slide presentation, that aggregation could include computing the total or weighted average score of a set of layout templates that produce a sequential set of slides. For a large-format poster presentation, this step can include aggregating the total or weighted average score of a set of deeply-nested layout templates that produce a single large layout. This aggregation can be supplemented with a weighting of other desirable factors, such as increasing the holistic score for presentations that consider whether particular templates should be reused, or not overused.

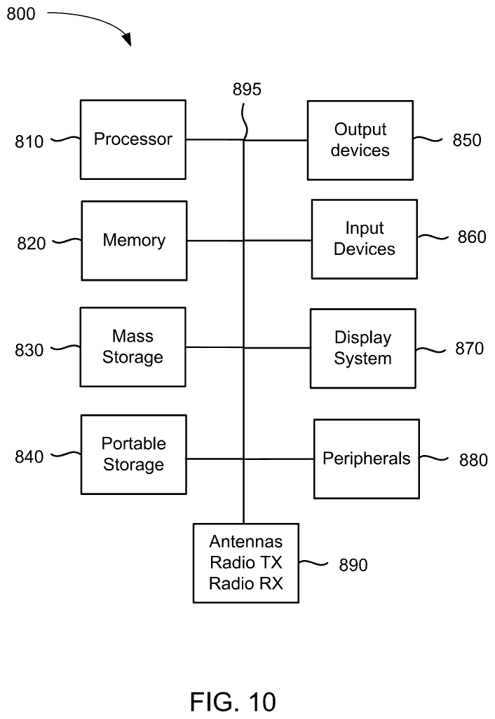

FIG. 10 is a block diagram of a computing environment for implementing the present technology. System 800 of FIG. 10 may be implemented in the contexts of the likes of machines that implement client device 110, application server 130, third party server 140, and data store 150. The computing system 800 of FIG. 10 includes one or more processors 810 and memory 820. Main memory 820 stores, in part, instructions and data for execution by processor 810. Main memory 820 can store the executable code when in operation. The system 800 of FIG. 10 further includes a mass storage device 830, portable storage medium drive(s) 840, output devices 850, user input devices 860, a graphics display 870, and peripheral devices 880.

The components shown in FIG. 10 are depicted as being connected via a single bus 895. However, the components may be connected through one or more data transport means. For example, processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive, an optical disk drive, a flash drive, or other device, is a non-volatile storage device for storing data and instructions for use by processor unit 810. Mass storage device 830 can store the system software for implementing embodiments of the present invention for purposes of loading that software into main memory 820.

Portable storage device 840 operates in conjunction with a portable non-volatile storage medium, such as a floppy disk, compact disk or Digital video disc, USB drive, memory card or stick, or other portable or removable memory, to input and output data and code to and from the computer system 800 of FIG. 9. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, system 800 as shown in FIG. 10 includes output devices 850. Examples of suitable output devices include speakers, printers, network interfaces, and monitors.

Display system 870 may include a liquid crystal display (LCD) or other suitable display device. Display system 870 receives textual and graphical information and processes the information for output to the display device. Display system 870 may also receive input as a touch-screen.

Peripherals 880 may include any type of computer support device to add additional functionality to the computer system. For example, peripheral device(s) 880 may include a modem or a router, printer, and other device.

The system of 800 may also include, in some implementations, antennas, radio transmitters and radio receivers 890. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 800 of FIG. 10 are those typically found in computer systems that may be suitable for use with embodiments of the present invention and are intended to represent a broad category of such computer components that are well known in the art. Thus, computer system 800 of FIG. 10 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically generating a presentation output, the method comprising:
displaying a user interface including a structured outline of a plurality of nodes;
receiving outline node information from the user through the user interface to form a populated outline; and
automatically generating a presentation output from the nodes of the populated outline.

2. The method of claim 1, further comprising linking an outline node to exhibit information in the structured outline, wherein the outline node is displayed with the exhibit information in the presentation output.

3. The method of claim 1, wherein the user can add and move nodes in the structured outline.

4. The method of claim 1, wherein automatically generating the presentation comprises:
selecting a group of nodes from the structured outline and comparing the group of nodes to predetermined presentation templates; and
automatically selecting and filling a presentation template with the corresponding outline node information for the selected group of nodes.

5. The method of claim 4, wherein each of the predetermined presentation templates comprises limits on content area, content amount, and/or content spacing, and a set of allowable variations in column widths and row heights to accommodate differences in node text length and linked exhibit dimensions.

6. The method of claim 4, wherein selecting the presentation template comprises identifying more than one presentation template that accommodates all nodes in the selected group of nodes.

7. The method of claim 6, further comprising:
identifying more than one presentation template that accommodates all nodes in the selected group of nodes; and
ranking the more than one presentation template relative to the selected group of nodes according to predetermined scoring rules as a function of spatial layout.

8. The method of claim 7, wherein the ranking comprises applying template layout rules on content area, content amount, and/or content spacing.

9. The method of claim 8, wherein the template layout rules comprise mapping higher level nodes to prominent spatial content areas of a template, and lower level nodes to less prominent content areas of a template.

10. The method of claim 1, further comprising automatically dividing the populated outline into independent sets of nodes.

11. The method of claim 10, further comprising ordering the independent sets of nodes to create an ordered list of nodes and generating the presentation output by comparing the independent sets of nodes to predetermined presentation templates.

12. Encoded software instructions stored on a non-transitory computer-readable medium and executable by a processor of a host computer system to carry out the method of claim 1.

13. A system comprising encoded software instructions stored on a non-transitory recordable medium and executable by a data processor to automatically generating a presentation output, the encoded instructions executable to:
display a user interface including a structured outline of a plurality of nodes, wherein a user enters outline node information through the user interface to form a populated outline; and
generate a presentation output from the nodes of the populated outline and the exhibit information.

14. The system of claim 13, wherein the encoded instructions allow for linking an outline node to exhibit information in the structured outline, wherein the outline node is displayed with the exhibit information in the presentation output.

15. The system of claim 13, wherein the user can add and move nodes in the structured outline.

16. The system of claim 13, wherein generating the presentation comprises:
selecting a group of nodes from the structured outline and comparing the group of nodes to predetermined presentation templates; and
automatically selecting and filling a presentation template with the corresponding outline node information for the selected group of nodes.

17. The system of claim 16, wherein each of the predetermined presentation templates comprises limits on content area, content amount, and/or content spacing.

18. The system of claim 16, wherein selecting the presentation template comprises identifying more than one presentation template that accommodates all nodes in the selected group of nodes.

19. The system of claim 18, further comprising:
identifying more than one presentation template that accommodates all nodes in the selected group of nodes; and
ranking the more than one presentation template relative to the selected group of nodes according to predetermined scoring rules as a function of spatial layout.

20. The system of claim 13, wherein the encoded instructions include dividing the populated outline into independent sets of nodes, and ordering the independent sets of nodes to create an ordered list of nodes and generating the presentation output by comparing the independent sets of nodes to predetermined presentation templates.
